(19) United States
(12) Patent Application Publication
(10) Pub. No.: US 2022/0042437 A1
(43) Pub. Date: Feb. 10, 2022

(54) CATALYTIC CONVERTER OPTIMIZER WITH CONTINUOUS PRE-HEATER

(71) Applicant: William G. DiSessa, Holly, MI (US)

(72) Inventor: William G. DiSessa, Holly, MI (US)

(21) Appl. No.: 16/986,691

(22) Filed: Aug. 6, 2020

(51) Int. Cl. F01N 3/20; F01N 11/00

(52) U.S. Cl. CPC F01N 3/2013; F01N 11/002; F01N 2240/16; F01N 2900/1602; F01N 2560/06; F01N 2590/08; F01N 2390/02

(57) ABSTRACT

A system for preheating a catalytic converter includes a catalytic converter. The system also includes an inductive heating device coupled with the catalytic converter and configured to heat the catalytic converter with inductive heating. The system further includes a primary battery coupled to the inductive heating device and configured to selectively provide power to the inductive heating device. Further still, the system includes a secondary battery coupled to the inductive heating device and configured to selectively provide power to the inductive heating device. Yet further still, the system includes a microcontroller configured to provide signaling which causes switching of powering of the inductive heating device between the primary battery and the secondary battery.

### TECHNICAL FIELD

The present disclosure relates to pre-heating of catalytic converters.

### BACKGROUND

The statements in this section merely provide background information related to the present disclosure and may not constitute prior art.

Catalytic converter prototypes were first designed in France at the end of the 19th century, consisting of an inert material coated with platinum, iridium, and palladium, sealed into a double metallic cylinder. A few decades later, Eugene Houdry patented the first catalytic converter. When the results of early studies of smog in Los Angeles were published, Houdry became concerned about the role of smokestack exhaust and automobile exhaust in air pollution and founded a company, Oxy-Catalyst.

A catalytic is an exhaust emission control device that reduces toxic gases and pollutants in exhaust gas from an internal combustion engine into less-toxic pollutants by catalyzing a redox reaction (an oxidation and a reduction reaction). Catalytic converters are usually used with internal combustion engines fueled by either gasoline or diesel—including lean-burn engines, as well as kerosene heaters and stoves.

Catalytic converters require a temperature of 800 degrees Fahrenheit (426° C.) to efficiently convert harmful exhaust gases into inert gases, such as carbon dioxide and water vapor.

Dimensions of catalytic converters vary but typically are 1 foot in diameter, from tip to tip; with a body that is 8-inches long and 5 inches in diameter, housed between an inlet and outlet each 2-inches long and 2.5 inches in diameter.

The first widespread introduction of catalytic converters was in the United States automobile market. To comply with the U.S. Environmental Protection Agency's stricter regulation of exhaust emissions, most gasoline-powered vehicles, since the 1975 model year, must be equipped with catalytic converters. These “two-way” converters combine oxygen with carbon monoxide (CO) and unburned hydrocarbons (CₙHₙ) to produce carbon dioxide (CO2) and water (H2O). In 1981, two-way catalytic converters were rendered obsolete by “three-way” converters that also reduce oxides of nitrogen (NOx); however, two-way converters are still used for lean-burn engines. This is because three-way-converters require either rich or stoichiometric combustion to successfully reduce NOx. Stoichiometric combustion is the ideal combustion process where fuel is burned completely. A complete combustion is a process burning all the carbon (C) to (CO2), all the hydrogen (H) to (H2O) and all the Sulphur (S) to (SO2). When burned, all fuel and air is consumed without any excess left over.

Although catalytic converters are most commonly applied to exhaust systems in automobiles, they are also used on electrical generators, forklifts, mining equipment, trucks, buses, locomotives, and motorcycles. They are also used on some wood stoves to control emissions. This is usually in response to government regulation, either through direct environmental regulation or through health and safety regulations.

The catalytic converter consists of many components:
A. The catalyst core, or substrate. For automotive catalytic converters, the core is usually a ceramic monolith with a honeycomb structure. Metallic foil monoliths made of FeCrAl are used in some applications. This is partially a cost issue. Ceramic cores are inexpensive when manufactured in large quantities. Metallic cores are less expensive to build in small production runs and are used in sportscars where low back pressure and reliability under continuous high load is required. Either material is designed to provide a high surface area to support the catalyst washcoat, and therefore is often called a “catalyst support”. The cordierite ceramic substrate used in most catalytic converters was invented by Rodney Bagley, Irwin Lachman and Ronald Lewis at Corning Glass, for which they were inducted into the National Inventors Hall of Fame in 2002.
B. The washcoat is a carrier for the catalytic materials and is used to disperse the materials over a high surface area. Aluminum oxide, titanium dioxide, silicon dioxide, or a mixture of silica and alumina can be used. The catalytic materials are suspended in the washcoat prior to applying to the core. Washcoat materials are selected to form a rough, irregular surface, which greatly increases the surface area compared to the smooth surface of the bare substrate. This, in turn, maximizes the catalytically active surface available to react with the engine exhaust. The coat must retain its surface area and prevent sintering of the catalytic metal particles even at high temperatures (1000° C.).
C. The catalyst itself is most often 3-4 gm of a precious metal. Platinum is the most active catalyst and is widely used but is not suitable for all applications because of unwanted additional reactions and high cost. Palladium and rhodium are two other precious metals used. Rhodium is used as a reduction catalyst, palladium is used as an oxidation catalyst, and platinum is used both for reduction and oxidation. Cerium, iron, manganese and nickel are also used, although each has its own limitations. Nickel is not legal for use in the European Union (because of its reaction with carbon monoxide into nickel tetracarbonyl). Copper in catalytic converters can be used everywhere except North America, where its use is illegal because of the formation of dioxin.

The three-way catalytic converter has three simultaneous tasks:

(1) Reduction of nitrogen oxides to nitrogen and oxygen: 2NOx→xO2+N2

(2) Oxidation of carbon monoxide to carbon dioxide: 2CO+O2→2CO2

(3) Oxidation of unburnt hydrocarbons (HC) to carbon dioxide and water: CxH2x+2+[(3x+1)/2]O2→xCO2+(x+1)H2O.

These three reactions occur most efficiently when the catalytic converter receives exhaust from an engine running slightly above the stoichiometric point. This point is between 14.6 and 14.8 parts air to 1-part fuel, by weight, for gasoline. In general, engines fitted with 3-way catalytic converters are equipped with a computerized closed-loop feedback fuel injection system using one or more oxygen sensors.

The catalytic converter was specifically invented to decrease harmful pollution caused by the combustion of hydrocarbon-based fossil fuels in cars. Studies reveal that these devices can decrease hydrocarbon emissions by about almost 87%, carbon monoxide by 85%, and nitrous oxide by 62% during the expected life of a vehicle.

However, cats only really work at high temperatures (over 300° C./600° F. or so), when the engine has had a chance to warm up. Early types of cats typically took about 10-15 minutes to warm up, so they were completely ineffective for the first few miles of a journey, or any part of a very short journey. Modern warm up in only 2-3 minutes; even so, significant emissions can still occur during this time.

Vehicles fitted with cats emit most of their total pollution during the first five minutes of engine operation; for example, before the catalytic converter has warmed up sufficiently to be fully effective.

Gasoline engines contribute to particulate emissions in the cities, too, especially in places where many engines do a cold start. Ninety (90) percent of all pollutants are produced in the first minute after a modern gasoline engine cold start.

Or to put it in another way: the first 500 meters on the road pollute the air just as much as the next 5,000 kilometers provided the vehicle would be driven nonstop.

Therefore, there is a need for a catalytic converter pre-heating system that can be used or integrated with existing catalytic converters or which can be designed from the ground up.

### SUMMARY

An illustrative embodiment relates to a system for preheating a catalytic converter. The system includes a catalytic converter. The system also includes an inductive heating device coupled with the catalytic converter and configured to heat the catalytic converter with inductive heating. The system further includes a primary battery coupled to the inductive heating device and configured to selectively provide power to the inductive heating device. Further still, the system includes a secondary battery coupled to the inductive heating device and configured to selectively provide power to the inductive heating device. Yet further still, the system includes a microcontroller configured to provide signaling which causes switching of powering of the inductive heating device between the primary battery and the secondary battery.

Another illustrative embodiment relates to a vehicle. The vehicle includes a combustion engine having an exhaust, a catalytic converter at least partially receiving the exhaust from the combustion engine, and an inductive heating device coupled with the catalytic converter and configured to heat the catalytic converter with inductive heating. A vehicle battery is coupled to the inductive heating device and configured to selectively provide power to the inductive heating device. A secondary battery is coupled to the inductive heating device and configured to selectively provide power to the inductive heating device. A microcontroller is configured to provide signaling which causes switching of powering of the inductive heating device between the vehicle battery and the secondary battery.

Yet another illustrative embodiment relates to a method of preheating a catalytic converter. The method includes determining whether there is available power in a primary power source and determining the temperature of the catalytic converter. The method also includes powering an inductive heating device coupled to the catalytic converter selectively based on the temperature of the catalytic converter and the available power in the primary power source.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is an illustrative embodiment of a flowchart of the continuous process involved with heating catalytic converters when a vehicle is running or idle.

FIG. 2 is an illustrative embodiment of a power flow diagram for the system.

FIG. 3 is an illustrative embodiment of a data flow diagram for the system.

FIG. 4 is an illustrative embodiment of an electrical schematic of the circuit board that, via its microcontroller, runs the continuous system for pre-heating the catalytic converter.

FIG. 5 is an illustrative embodiment of a catalytic converter optimizer.

FIG. 6 is an alternative embodiment of an optimizer.

FIG. 6a is another alternative embodiment of an optimizer.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In accordance with an illustrative embodiment, a catalytic (sometimes referred to as cat) heater or optimizer applies inductive heating technology and a continuous, self-sustaining, closed-loop system or process for quickly pre-heating a catalytic converter to its optimal temperature range of 300-350° C. after vehicle ignition using the vehicle battery; maintaining an idle temperature of 220° C. when the vehicle ignition is off, through a recurring series of warm-ups, using the optimizer's rechargeable batteries so as to not drain the vehicle battery, whenever the optimizer registers a temperature below 200° C.; and using the vehicle battery to recharge the optimizer's batteries when the vehicle ignition is on.

Induction heating was discovered by Michael Faraday as he studied the induction of currents in wires by a magnet. The fundamental principles of induction heating were later established and developed by James C. Maxwell in his unified theory of electromagnetism. James P. Joule was the first to describe the heating effect of a current flowing through a conductive material.

Induction heating is a fast and efficient contactless method for heating conductive materials such as metals and semiconductors by applying a fluctuating magnetic field. It has advantages over traditional heating techniques (resistance heating, flame heating, ovens, furnaces, etc.). Induction heating is particularly useful for performing highly precise or repetitive operations.

An alternating current source is used to supply current to an induction heating element such as a copper, aluminum or brass coil with a diameter of, but not limited to approximately 5 mm.

These metals have high thermal conductivity rankings of 223, 118, and 64 [BTU/(hr·ft·° F.)], respectively.

The advantages of applying inductive heating technology to the problem of inefficient catalytic converters generally include:
Reduced time—the target is heated directly, resulting in a reduction of both heating time and wasted heat. This method provides high power density and low or no thermal inertia.
High efficiency—efficiency values higher than 90% are obtained due to the proper design of the power converter and the heating element. In addition, high temperatures can be reached quickly and easily as the ambient heat loss is significantly reduced.
Improved control—precise regulation of the heating power can be achieved via appropriate heating element and control of the power converter. As a result, additional features such as local heating, and pre-heating, predefined temperature profiles may be implemented.
Industrial automation option—allows improvement of both the productivity and the quality of the processes. Quality is additionally guaranteed as the heating is contactless (no interference by the heating tool).
Safety and cleanliness—there are no thermal or air pollution as the target is heated directly and no fuel substances are used.

A method comprising a coiled inductive heating element which closes over the body of a catalytic converter or, optionally, is basket-shaped with a semi-coiled heating element that fits under the midpoint of the catalytic converter's body. The coiled or semi-coiled inductive heating element draws power to pre-heat the catalytic converter from the vehicle battery after vehicle ignition, then switches to its own on-board, backup battery system to pre-heat the catalytic converter when the ignition is off. This increases the catalytic converter's optimal performance without draining the vehicle battery or adversely affecting catalytic converter integrity, operations or output. An illustrative embodiment includes a closed-loop system, guided by a microcontroller, to continuously check for vehicle ignition and whether the temperature of the catalytic converter has fallen beneath a threshold or margin of, e.g., 200° C. when the vehicle is idle. When the ignition turns on, the system pre-heats the catalytic converter using the vehicle battery and stops applying heat when the catalytic converter reaches optimal operating temperature. At the same time, the vehicle battery recharges the system's batteries. When the ignition is off, the system monitors the catalytic converter's temperature and, powered now by the system's own batteries, begins to pre-heat the catalytic converter when it falls below 200° C. Only if the ignition is off for a prolonged period, and the system's batteries are no longer able to power the heating element, will the system be interrupted until the next vehicle ignition.

The microcontroller and battery system are located on a circuit board that provides system operations and intermittently warms up the catalytic converter, as necessary and per system parameters.

This technology can benefit all vehicle models and years, especially older vehicles with longer cat warm-up times, as well as virtually all catalytic converters. It can be added to a new vehicle production line or installed on older vehicles as an aftermarket product. Adavantages of using inductive pre-heating include but are not limited too reduction of harmful emission, and increased fuel efficiency by using an ionductive heating element that is efficient with lower battery usage than would be a resistance type heating element

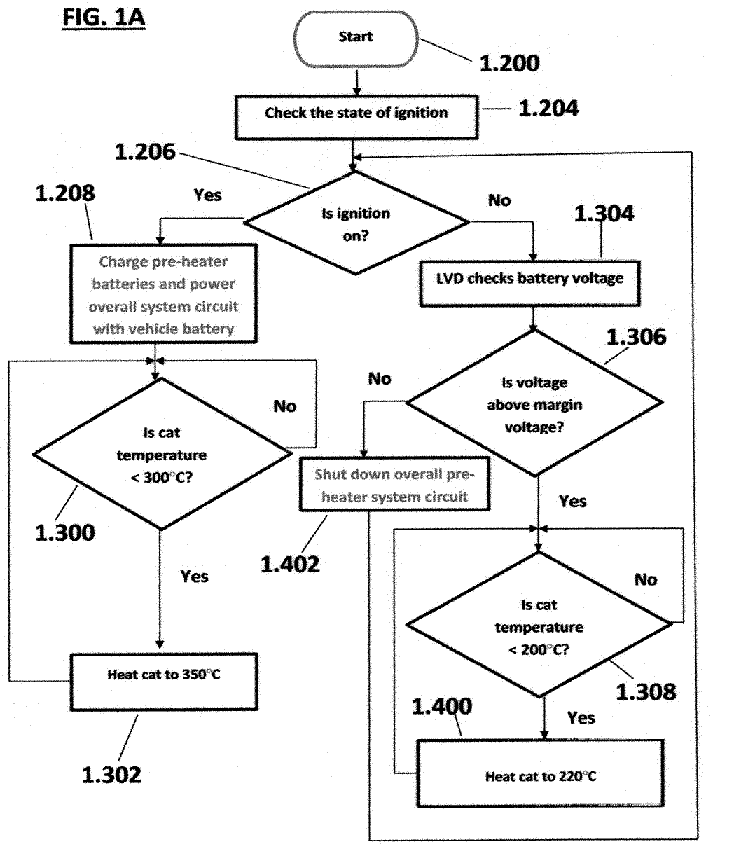

Referring now to FIG. 1, a flow diagram for a catalytic converter pre-heater inductive heating system is depicted. The process Starts at a step 1.200, and the manual switch is turned to ON, where the computer-based logic checks the state of the ignition (process 1.204)

If the ignition is ON, then the logic sends a command to charge the optimizer batteries and power the optimizer with power supplied directly from the car battery (process 1.208).

The margin temperature is set to 300° C. in the microcontroller and the microcontroller checks to see whether the cat temperature is less than 300° C. (process 1.300) The optimizer then heats up the cat above the margin temperature regardless of the idleness of the optimizer and maintains its temperature at the margin temperature (process 1.302).

At step 1.206, if the ignition is OFF, the Low Voltage Disconnect (LVD) circuit checks the margin voltage of the batteries (process 1.306). If the battery voltage is below a margin voltage (process 1.306), the LVD shuts down the optimizer (process 1.402). If the battery voltage is above the margin voltage (process 1.306), the margin temperature is set to 200° C. in the microcontroller (process 1.308). The optimizer then heats up the cat slightly above the margin temperature (e.g. 220° C.) and maintains its temperature at the margin temperature (process 1.400).

These processes may then be continually looped as the state of the vehicle changes dynamically throughout each step of the process

The margin voltage may be set during the circuit design of the LVD circuit. The LVD may prevent the batteries from over draining as well as maintains the operation duration of the optimizer in idle mode. There may also be a manual switch to turn off the overall optimizer system for mechanical repair and maintenance.

The automation algorithm in the catalytic converter optimizer (AKA system or process) will enable following features:
a. Does not allow the optimizer to stay in idle mode for longer time when the car remains unused—The manual switching of the optimizer when the car is to remain unused for a longer time, may be eliminated by the LVD itself. The LVD may be attached to the battery of our optimizer which may control the overall power flow to the optimizer circuit as discussed earlier in the power flow diagram. Since our batteries will be powering the optimizer for at most 24 hours straight, the LVD disconnects the optimizer circuit when the batteries do not get recharged for more than a day, i.e. the vehicle remains unused for more than a day. Since, for all those users who have a daily routine to drive to work, use their vehicle on a daily basis, the optimizer operates at idle mode at all times. Now, for the weekends when the vehicles might not be used for more than a day or on any situation when the vehicle remains unused for longer, the feature below resolves the situation.
b. Enable fast heating of the optimizer when ignition is turned on, even after the vehicle is used after a long time—Whenever the ignition is turned on, the circuit may be so designed that the car battery itself may power the optimizer circuit and the induction heater while also charging the optimizer batteries. Since the car battery has a higher current and voltage capacity, the induction heater heats up the optimizer to operating temperature i.e. 300° C. at a higher rate. This may enable the optimizer to warm up in short interval. In situations when the optimizer is at idle mode, warmup time will be even shorter since when ignition is turned on, the car battery will take even less time to heat the optimizer from 200° C. to 300° C. Now, when the LVD has shut down the optimizer, the optimizer will get back to working mode when the ignition is turned on. So, when the vehicle remains unused for long time even in ice cold conditions, as long the car batteries are fine, the optimizer can warm up the cat.

With the use of the automation algorithm, the load from the optimizer batteries may be slightly reduced since, the car batteries will kick in to power the optimizer when the ignition is turned on.

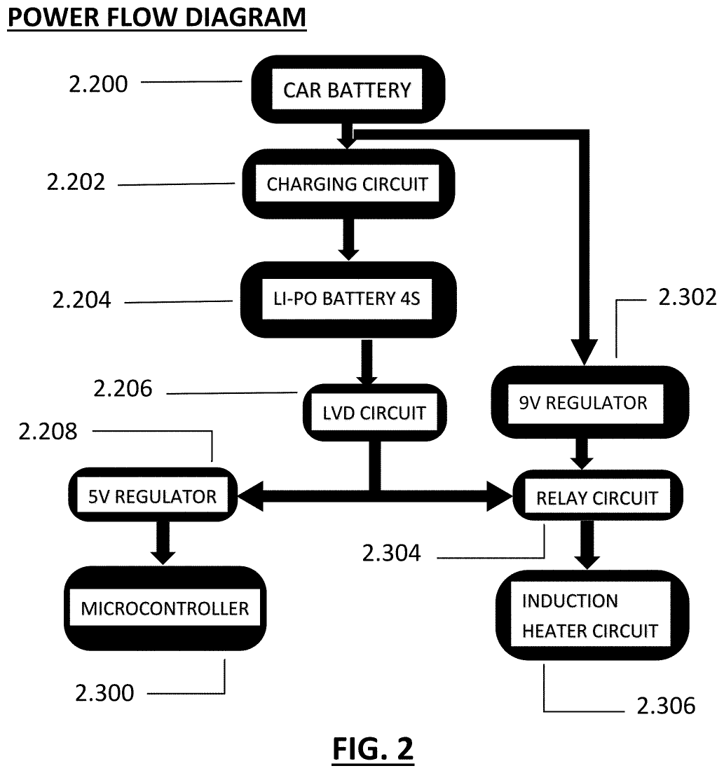

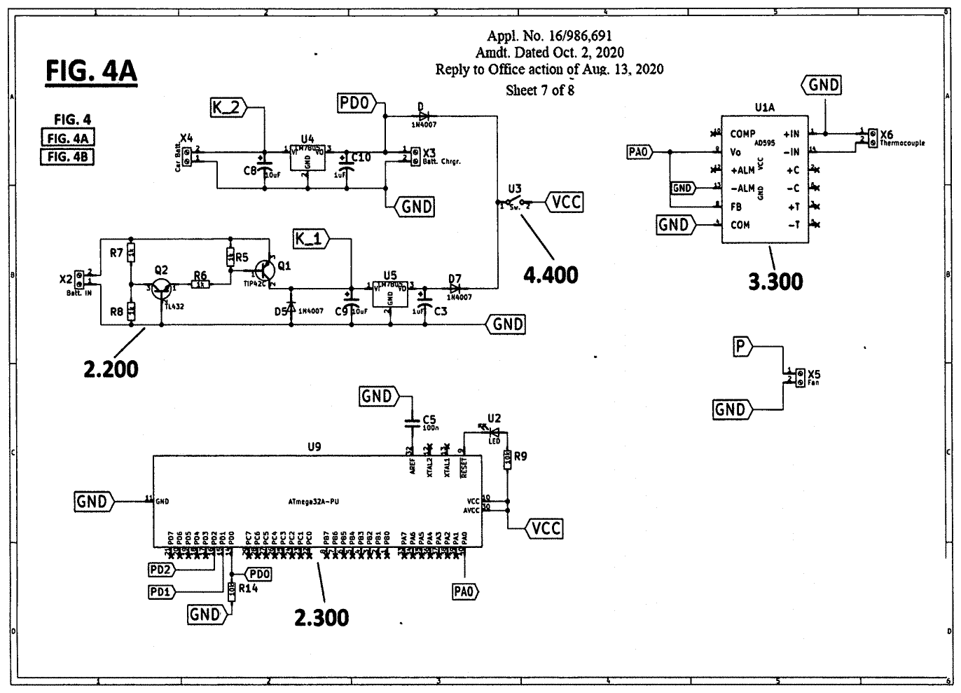

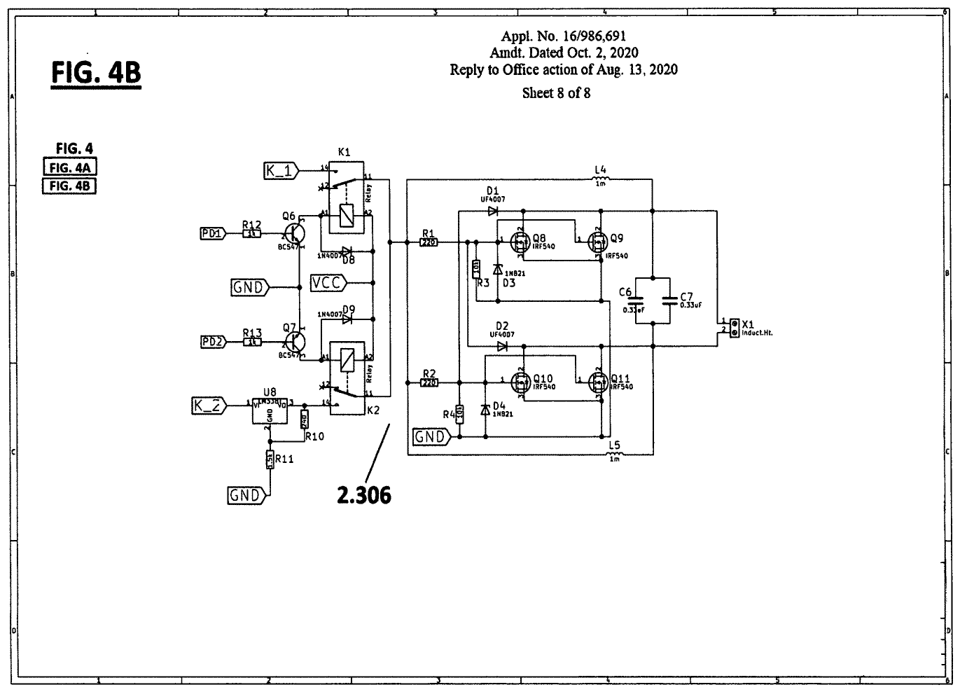

Referring now to FIGS. 2 and 4, an illustrative embodiment of catalytic converter pre-heater inductive heating system is depicted. A car battery 2.200 is configured as the main source of power for the pre-heater. It delivers power to the overall system during initial ignition phase and also to the batteries that maintain the pre-heater at standby mode when the vehicle remains unused.

A charging circuit 2.202 maintains the charging voltage to the batteries at a rated charging voltage. Since the voltage provided by the car battery is higher than the rated charging voltage, it is thus required to regulate the car voltage down to the charging voltage.

The 4s battery 2.204 may be a combination of 4 Li—Po batteries connected together in a series but may be any other variety of batteries. This configuration adds up the individual output voltage of each battery to give higher total output voltage. However, it is important to keep in mind that a charging module must be allocated to each battery used in the combination. This allows each battery to be charged individually from the same charging circuit mentioned above. Also, the number of batteries in series combination can be increased as required by the user.

In accordance with an illustrative embodiment, an LVD circuit 2.206 is analogous to the fuel controller used in motorbikes. The fuel controller shuts the fuel passage to the engine when the fuel level reaches a threshold value, generally 5% of total fuel capacity. Similar to the fuel controller, the LVD also shuts down the power flow from the Li—Po batteries into the pre-heater system in order to protect the batteries from complete discharge. The battery life is drastically reduced when they get discharged completely. So, for longer battery life the LVD plays a crucial role.

A 5V regulator 2.208, as its name suggests, is responsible to provide a regulated voltage of 5V which powers all the logical and relay circuits in the system. These circuits may be seriously damaged if the supply voltage fluctuates to extreme values outside its operating range.

A microcontroller 2.300, that is analogous to the human brain, takes data from sensors and controls all the output operation. The microcontroller is a lower version of the microprocessor that are used in the computers. But unlike the microprocessor, the microcontroller includes a built-in memory and I/O pins that store the program code and operate all input output operations respectively.

The 9V regulator 2.302 provides a steady 9V supply to the induction heater circuit. This leads to a question, why not use the same regulated 5V for the induction heater circuit? Since the power delivered by the induction heater is dependent upon the input voltage to the circuit, it is thus necessary to provide higher input voltage. Considering the source voltage of car battery and the Li—Po batteries, the input voltage to the induction heater must be calibrated within the range of both sources.

A relay circuit 2.304 that is like the clutch pedal used in vehicles that channel the power from engine to gears, triggers the flow of power from the 9V regulator to the induction circuit. The microcontroller directs the relay and thus controls the overall power flow.

An induction heater circuit 2.306 is basically a circuit that converts the steady DC supply into a high frequency AC supply. For the induction heating, the circuit requires a high frequency AC voltage that passes through the conducting coil and thus inducing heat via mutual induction.

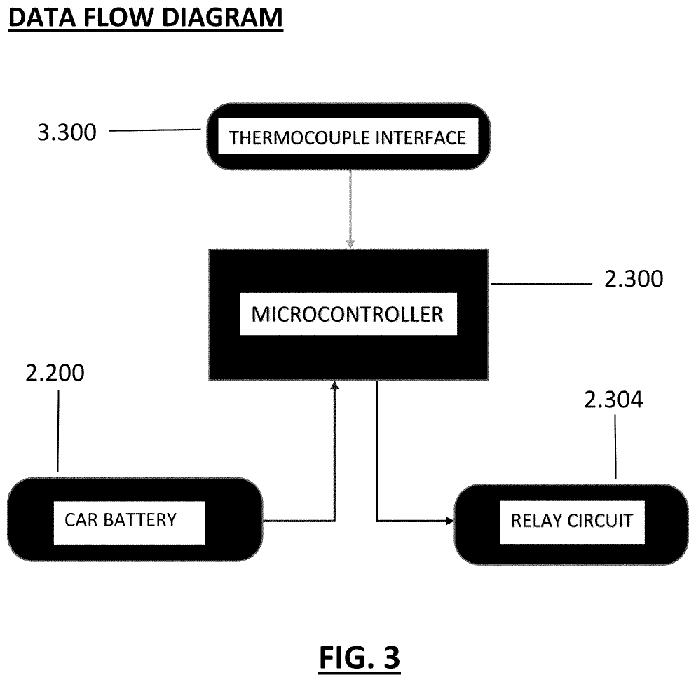

Referring now to FIGS. 3 and 4, a microcontroller 2.300 is depicted interfacing with various components. A thermocouple interface 3.300 acts like a mediator between the thermocouple and microcontroller 2.300. The sensor data from the thermocouple is significantly of low voltage range and is not recognized by the input pins of microcontroller 2.300. So, the thermocouple interface boosts the data range of the thermocouple which is then understood by microcontroller 2.300.

Microcontroller 2.300 takes input data from thermocouple interface 3.300 which indicates the temperature value and also triggers the relay circuit via output pin. The overall input and output are controlled by the program code stored in its memory, which instructs microcontroller 2.300 to perform certain logical and arithmetic operations. Microcontroller 2.300 also detects whether the ignition is ON by detecting the voltage value if supplied by the car battery to its input pin.

Microcontroller 2.300 also gets charge status information from car battery 2.200 and provides information to relay circuit 2.304 on whether to accept charge from car batter 2.200 or from Li—Po Battery 2.204.

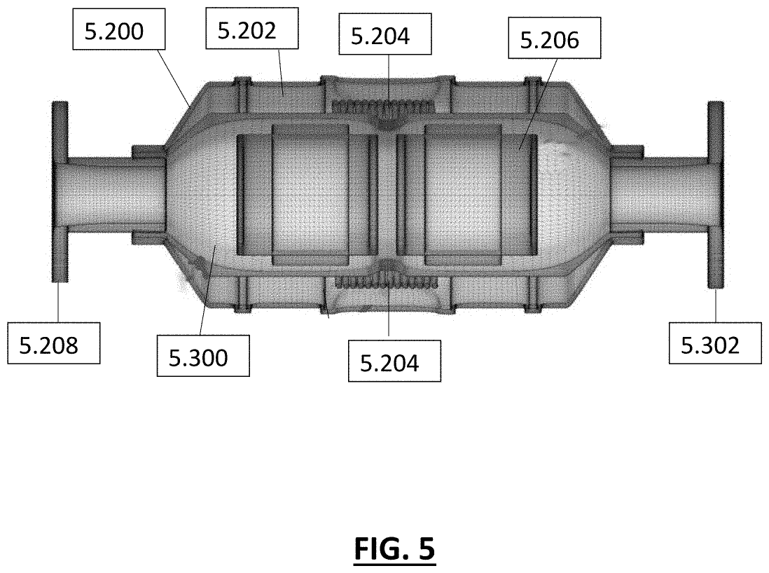

Referring now to FIG. 5 an illustrative embodiment of an optimizer 5.200 is depicted. Optimizer 5.200 may be used to intermittently heat a catalytic converter per the algorithm. A heat incubator 5.202 encloses the catalytic converter. This maximizes system heating performance while decreasing its reserve Li—Po 4s batteries (2.204). Optimizer 5.200 includes an inlet 5.208 to the catalytic converter and an outlet 5.302 from the catalytiuc converter.

One example embodiment of 5.200 may include a protective, insulating layer of Silicone Carbide, ceramic or metallic honeycomb to help retain heat that warms the catalytic converter. This layer may serve as the exterior or outer surface or cover of 5.200 or an interior layer about 0.25″ inch wide. In some example embodiments the layer may be formed of honeycombs which are most often an array of hollow hexagonal cells with thin vertical walls. The honeycomb pattern has a high strength-to-weight ratio.

A Silicon Carbide Honeycomb is low density permeable material with a very high porosity, typically 75-95% of the volume consists of void spaces. The geometric structure of Silicon Carbide honeycomb allows for the minimization of material used thus lowering weight and cost. Like diamond, a pure carbon compound, Carbide compounds tend to be extremely hard, refractory and resistant to wear, corrosion and heat. They often have other valuable properties in combination with toughness, such as electrical conductivity, low thermal expansion and abrasiveness. Metallic Honeycomb has found a wide variety of applications in heat exchangers, energy absorption, flow diffusion and lightweight optics. Ceramic Honeycomb is often used for thermal insulation, acoustic insulation, adsorption of environmental pollutants, filtration of molten metal alloys, and as substrate for catalysts requiring large internal surface area. Other insulative layers may also be used besides those described above without departing from the scope of the invention.

In an illustrative embodiment, a copper coil or heating element 5.204 may be used that curves around the internal casing (5.300) of the catalytic converter, specifically around its ground-facing side. Honeycomb material 5.206 may be housed in the internal casing 5.300 of the catalytic converter.

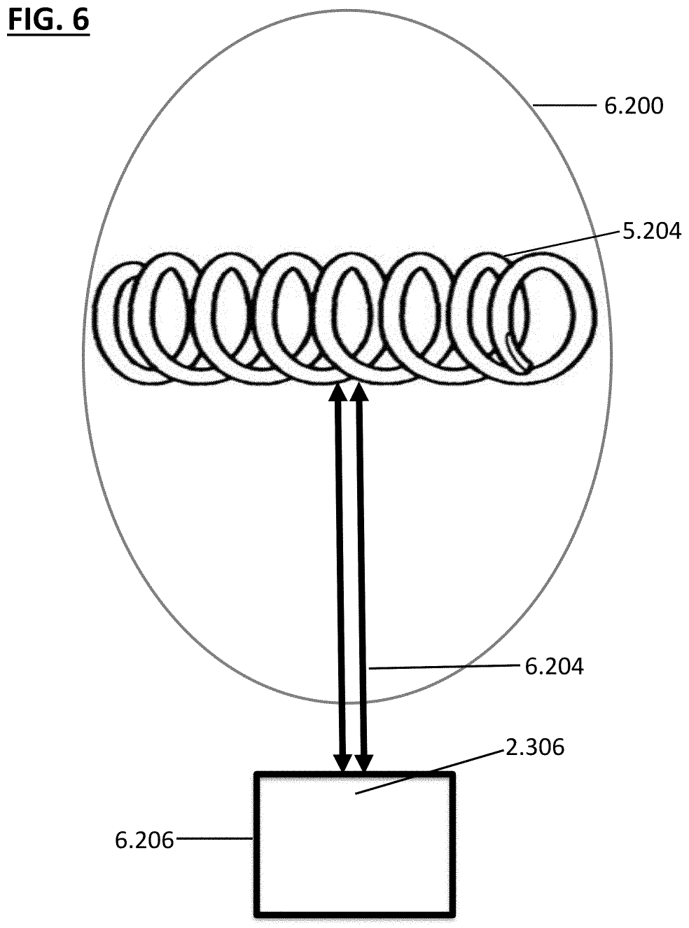

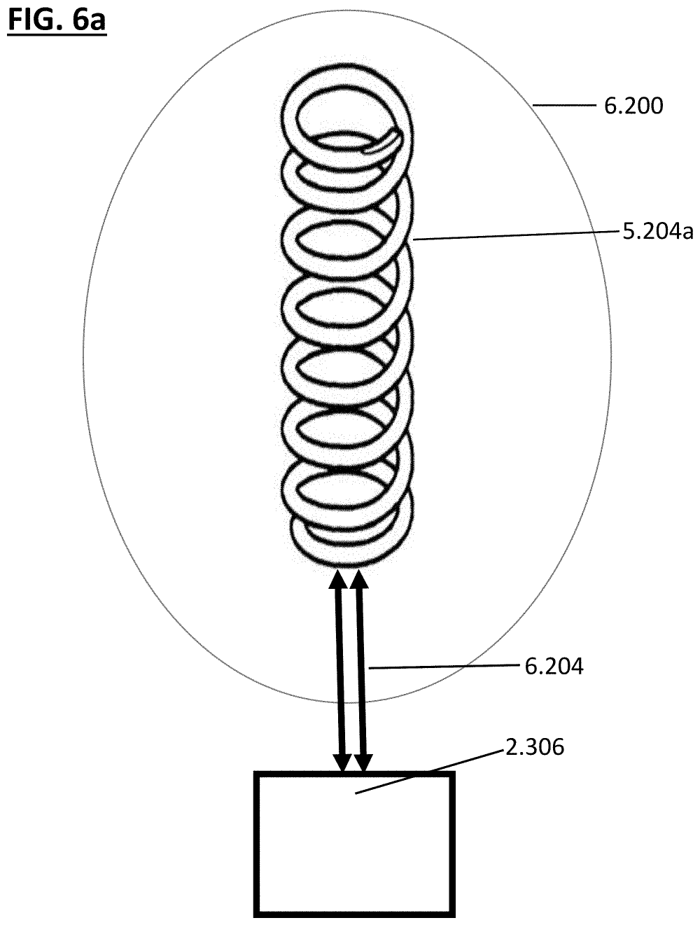

Referring now to FIG. 6, 6.200 is another example embodiment of the catalytic converter optimizer, shown in FIG. 5, which closes around the catalytic converter. This alternative embodiment may be basket-shaped, made of aluminum about ⅛″ thick, and contains the same copper coil or heating element, 5.204 of FIG. 5, that stretches horizontally along the midsection of the catalytic converter. The heating element 5.204 and basket lay directly under the catalytic converter. The aluminum basket is bolted or otherwise fastened to the circuit board's container (6.206) so it is not necessary to attach the basket to the vehicle undercarriage or frame. The box-shaped container may be made of plastic or aluminum with example dimensions of about 1′×1′×4″, which n are not limiting. Two wires 6.204 connect the heating element 5.204 with the Induction Heater Circuit 2.306 on the circuit board.

Referring now to FIG. 6a another example embodiment of the catalytic converter optimizer 6.200 of FIG. 6. This alternative embodiment is generally the same as shown in FIG. 6, except its copper coil or heating element (5.204a) stretches vertically along the length of the catalytic converter, rather than horizontally in 5.204.

The continuous application of efficient induction heating, as provided by the present invention, is shown to increase cat operational efficiency and to significantly reduce carbon dioxide emissions into the environment.

It is important to note that when the induction heating system is in idle mode, the cat remains at ambient temperature. When in standby mode, the automation algorithm maintains the temperature of the cat between 200° C. and 220° C.

Several system improvements are shown under various conditions:

When the Induction Heater is at Idle Mode
Considering an ambient temperature of −5° C., total reduction in warm-up time for early model cats is about 4 minutes; for modern cats, it's 0.23 minutes or 14 seconds. These percentages are based on early model cats and modern cats requiring 10 to 15 minutes and 2 to 3 minutes, respectively, to reach optimal operating temperature.
Considering an ambient temperature of 20° C., total reduction in warm-up time for early model cats is about 5 minutes; for modern cats, it's 0.42 minutes or 25 seconds.

When the Induction Heater is at Standby Mode
When the system is on standby and the vehicle ignition is off, the system maintains cat temperature between 200° C. and 220° C. So, the upper and lower temperature values maintained by the system are 220° C. and 200° C., respectively. Total reduction in time it takes to warm up an early model cat from 200° C. to 300° C. is about 10 minutes. For modern cats, it's about 2 minutes.
At 220° C., with the early model cat warmed up by the system but the ignition still off, total reduction in warm-up time is 11 minutes. For modern cats, it's about 2 minutes.

The following graphs demonstrate the overall reduction in warm up time for early and modern cats under idle and standby mode of heating system:

Overall carbon dioxide emissions by vehicles per mile, with and without use of the induction heating system, for early and modern cats are tabulated below.

| | Carbon dioxide emission by vehicles at different conditions (10\hat{ }−4 metric tons) | | | | | |
|---|---|---|---|---|---|---|
| | Without pre-CAT | | With pre-CAT (idle) | | With pre-CAT (standby) | |
| | Arterial Rd. | Freeway Rd. | Arterial Rd. | Freeway Rd. | Arterial Rd. | Freeway Rd. |
| Early CATs | 25.2 | 41.9 | 16.8 | 28.1 | 5.52 | 9.18 |
| Modern CAB | 5.04 | 8.38 | 4.55 | 7.61 | 1.51 | 2.52 |

The maximum reduction in such emissions for early model cats during the system's initial warmup stage is calculated at 78 percent in arterial roads (all figures are rounded, if necessary). The calculation for maximum percentage reduction is given by:

$$\begin{matrix}Maximum Percentage reduction = [ ( 25.2 - 5.52 ) / 25.2 \times 100 ] \% \\ = 78.09 \%\end{matrix}$$

Here, 25.2 refers to carbon dioxide emission (10\hat{ }-4 metric ton/mile) by vehicles using early cats on arterial roads and 5.52 refers to emissions while using the induction heating system in standby mode along with early cats on arterial roads.

For modern cats, which warm up faster, it's 70 percent, based on a similar calculation. These percentages apply to vehicles on freeway or arterial roads. Factors considered in the above results include:
Ambient, cat, and exhaust temperatures while the system is on standby with vehicle ignition is off and while ignition is on, and whether vehicle is warmed up or not;
Steel for cat casings is used in calculations and scenarios;
   weight and heat capacity of steel cats, including their ceramic cores representing about 20 percent of their total weight. The specific heat capacity of stainless steel is 468 J/kg K;
Power contributed by hot engine exhaust gas for heating the cat (i.e. P and P′) is considered constant throughout the calculations; based on data referred from FHWA 2019 and EPA 2019, total carbon emission by a fuel-burning vehicle per mile is 4.03×10⁻⁴ metric tons CO₂E/mile;
60 W power deliverance by the induction circuit; and
induction coil consists of 5 mm-diameter copper pipe commonly used in air conditioners and refrigerators.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

1. A system for preheating a catalytic converter, comprising:
a catalytic converter;
an inductive heating device coupled with the catalytic converter and configured to heat the catalytic converter with inductive heating;
a primary battery coupled to the inductive heating device and configured to selectively provide power to the inductive heating device;
a secondary battery coupled to the inductive heating device and configured to selectively provide power to the inductive heating device;
a microcontroller configured to provide signaling which causes switching of powering of the inductive heating device between the primary battery and the secondary battery.

2. The system of claim 1, wherein the catalytic converter is for a vehicle.

3. The system of claim 1, wherein the primary battery includes a vehicle battery.

4. The system of claim 1, wherein the secondary battery includes a Li—Po battery.

5. The system of claim 1, wherein the microcontroller receives charge information from the primary battery.

6. The system of claim 1, wherein the microcontroller receives charge information from the secondary battery.

7. The system of claim 1, further comprising:
a thermocouple, the thermocouple configured to measure a temperature of the catalytic converter and to provide the temperature information to the microcontroller.

8. The system of claim 1, further comprising:
a relay circuit receiving the signaling from the microcontroller and causing switching between the primary battery and the secondary battery.

9. A vehicle, comprising:
a combustion engine having an exhaust,
a catalytic converter at least partially receiving the exhaust from the combustion engine;
an inductive heating device coupled with the catalytic converter and configured to heat the catalytic converter with inductive heating;
a vehicle battery coupled to the inductive heating device and configured to selectively provide power to the inductive heating device;
a secondary battery coupled to the inductive heating device and configured to selectively provide power to the inductive heating device;
a microcontroller configured to provide signaling which causes switching of powering of the inductive heating device between the vehicle battery and the secondary battery.

10. The system of claim 9, wherein the catalytic converter is for an automotive vehicle.

11. The system of claim 9, wherein the catalytic converter is for a locomotive vehicle.

12. The system of claim 9, wherein the secondary battery includes a Li—Po battery.

13. The system of claim 9, wherein the microcontroller receives charge information from the vehicle battery.

14. The system of claim 9, wherein the microcontroller receives charge information from the secondary battery.

15. The system of claim 9, further comprising:
a thermocouple, the thermocouple configured to measure a temperature of the catalytic converter and to provide the temperature information to the microcontroller.

16. The system of claim 9, further comprising:
a relay circuit receiving the signaling from the microcontroller and causing switching between the vehicle battery and the secondary battery.

17. A method of preheating a catalytic converter, comprising:
determining whether there is available power in a primary power source;
determining a temperature of the catalytic converter;
powering an inductive heating device coupled to the catalytic converter selectively based on the temperature of the catalytic converter and the available power in the primary power source.

18. The method of claim 17, further comprising:
determining whether there is available charge in a secondary power source.

19. The method of claim 18, further comprising:
powering the inductive heating device coupled to the catalytic converter selectively based on the temperature of the catalytic converter and the available power in the secondary power source.

20. The method of claim 19, further comprising:
shutting down power being delivered to the inductive heating device based on the temperature of the catalytic converter, the available power in the primary power source and the available power in the secondary power source.
